(19) United States
(12) Patent Application Publication
(10) Pub. No.: US 2007/0223424 A1
(43) Pub. Date: Sep. 27, 2007

(54) System and method for restricting packet data services in a wireless communications network

(75) Inventors: Daisy Feng-Mei Su, Naperville, IL (US); Alex Ibrahim Moukalled, Naperville, IL (US)

Correspondence Address: Richard J. Minnich, Esq.;Fay, Sharpe, Fagan, Minnich & McKee, LLP, Seventh Floor, 1100 Superior Avenue, Cleveland, OH, 44114-2579, US

(73) Assignee: Lucent Technologies Inc.

(21) Appl. No.: 11/387,605

(22) Filed: Mar. 23, 2006

(51) Int. Cl. H04B 7/216

(52) U.S. Cl. 370/335

(57) ABSTRACT

A geographic Hot Zone service for restricting wireless packet data sessions transmitted to/from a restricted geographic Hot Zone created within the coverage area of a wireless packet data communications network is provided. The geographic Hot Zone service is activated to create the Hot Zone during an extraordinary event and reduces the number of packet data sessions in the Hot Zone to only those involving a limited number of authorized Mobile Stations, such as those used by police, firefighters, and other emergency personnel.

### BACKGROUND OF THE INVENTION

This invention relates to a system and method for providing packet data services in a wireless telecommunications network and more particularly to a system and method for restricting packet data services to authorized mobile stations located in particular geographic areas.

While the invention is particularly directed to the art of wireless telecommunications networks including Radio Access Networks and. Packet Core Networks, and will be thus described with specific reference thereto, it will be appreciated that the invention may have usefulness in other fields and applications.

A wireless telecommunications network enables a Mobile Station to provide voice communications to a user while the user moves about over a considerable geographic area, that area being within the coverage of the network. With the integration of a Packet Data Core Network to the Radio Access Network, wireless telecommunications networks can now enable a Mobile Station to provide packet data services to mobile users. These packet data services can include communicating with the Internet via the Mobile Station.

However, during a “State of Emergency”, a natural disaster, or other extraordinary events, it is desirable to restrict wireless packet data services to only authorized priority callers such as emergency personals and police enforcement personnel in the vicinity of the event.

Currently, wireless communications Service Providers can restrict the access of its radio system for the circuit calls to a limited number of Mobile Stations, such as those used by emergency personnel and police enforcement, based on the ISDN User Part (ISUP) Initial Address Message (IAM). This function is useful when there is a State of Emergency in the Hot Zone, the restricted geographical area. For example, there is an issue with a terrorist using the wireless telecommunication network to trigger a bomb remotely. It is not wise to shut down the entire wireless communication system for a potential small geographic area once identified because of the loss of revenues and the loss of the communication systems for the emergency crews.

However, the current implementation does not apply to the wireless packet data services. In the State of Emergency, wireless operators would be forced to shut down its networks in the Hot Zone and thus would not be able to support the operations of the emergency personnel.

It is therefore desirable to provide a system and method for restricting packet data services to a limited number of authorized personnel in the vicinity of an extraordinary event.

### SUMMARY OF THE INVENTION

A system and method for restricting wireless packet data services within a temporary restricted geographic Hot Zone to limited number of authorized mobile stations is provided.

In accordance with a first aspect of the invention, the method includes activating a restricted Hot Zone service creating a temporary restricted geographic Hot Zone within the coverage area of the Radio Access Network, receiving a request for establishing a wireless packet data session with the Radio Access Network and the Packet Data Core Network for a first Hot Zone Mobile Station located in the Hot Zone, determining that the first Hot Zone Mobile Station is an authorized Hot Zone Mobile Station, wherein the group of authorized Hot Zone Mobile Station are a subset of all Mobile Stations authorized to engage in wireless packet data sessions transmitted over the Radio Access Network and the Packet Core Network when located in the geographic area of the Hot Zone while the restricted geographic Hot Zone service is not activated, and establishing a wireless packet data session with the Radio Access Network and the Packet Core Network for the authorized Hot Zone Mobile Station, receiving a request for establishing a wireless packet data session with the Radio Access Network and the Packet Core Network for a second Hot Zone Mobile Station located in the Hot Zone, determining that the second Hot Zone Mobile Station is an unauthorized Hot Zone Mobile Station, and rejecting the request thereby not establishing the wireless packet data session for the unauthorized Hot Zone Mobile Station.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram illustrating a system for providing a restricted geographic Hot Zone service in accordance with the invention;

FIG. 2 is a flow chart illustrating a method for providing a restricted geographic Hot Zone service in accordance with the invention; and

FIG. 3 is a flow chart illustrating a method for providing a restricted geographic Hot Zone service in accordance with the invention.

### DETAILED DESCRIPTION OF THE PREFERRED EMBODIMENTS

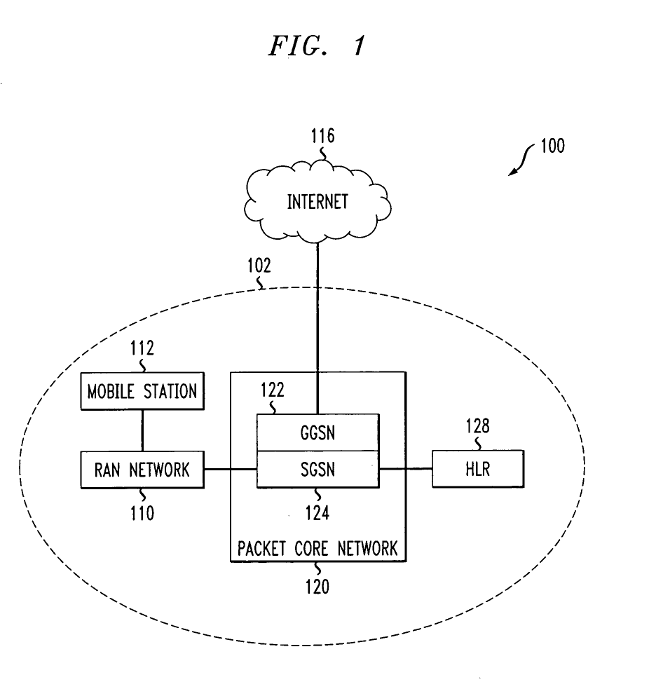

Referring now to the drawings wherein the showings are for purposes of illustrating the preferred embodiments of the invention only and not for purposes of limiting same. In FIG. 1, a system for providing Packet Data Services to authorized Mobile Stations in a restricted Hot Zone is shown generally at 100.

The system 100 includes one or more network elements of a wireless telecommunications network, shown generally at 102, also referred to as a cellular or mobile telecommunications network capable of providing packet-based communications. The network includes a Radio Access Network (RAN) 110 suitable for providing wireless telecommunications services, also known as cellular services, to Mobile Stations, one of which is shown at 112. The RAN 110 can be a CDMA network, a GSM/GPRS, an UMTS network or some other suitable cellular network.

The Mobile Station 112 is capable of sending and/or receiving packetized data during a Packet Data Session, also referred to as Packet Data Services, to a Packet Network 116, an example of which can include the Internet, via a Packet Core Network (PCN) 120. The Mobile Station 112 can be a mobile phone having data capabilities, or a computing device such as for example a laptop computer having a wireless modem, among others.

The Packet Core Network 120 can be a General Packet Radio Service (GPRS) network including a Gateway GPRS Support Node (GGSN) 122, acting as the intermediary between the RAN 110 and the external Packet Network 116. The GGSN 122 oversees the Packet Network address handling, such as for example Internet Protocol (IP) address handling and routes data packets into and out of the RAN 110.

The Packet Core Network 120 also includes a Serving GPRS Support Node (SGSN) 124 that sends data to and receives data from Mobile Stations 112, and maintains information about the location of the Mobile Stations. The SGSN 124 communicates between the MS and the GGSN for providing conversion between Packet Network formats and those used in the RAN 110. The SGSN 124 is responsible for the mobility management and IP packet session management. It routes user packet traffic from the RAN 110 to the appropriate GGSN.

The system 100 can also include a Home Location Register (HLR) 128 for storing subscription service information, also known as subscriber profiles, for mobile subscribers to the RAN 110. The subscriber profiles can be associated with the subscriber, or the subscriber's Mobile Station 112, in any suitable known manner such as for example by phone number (MDN) or International Mobile Subscriber Identity (IMSI), among others. The HLR 128 can also store location information for the Mobile Station 112 for call routing.

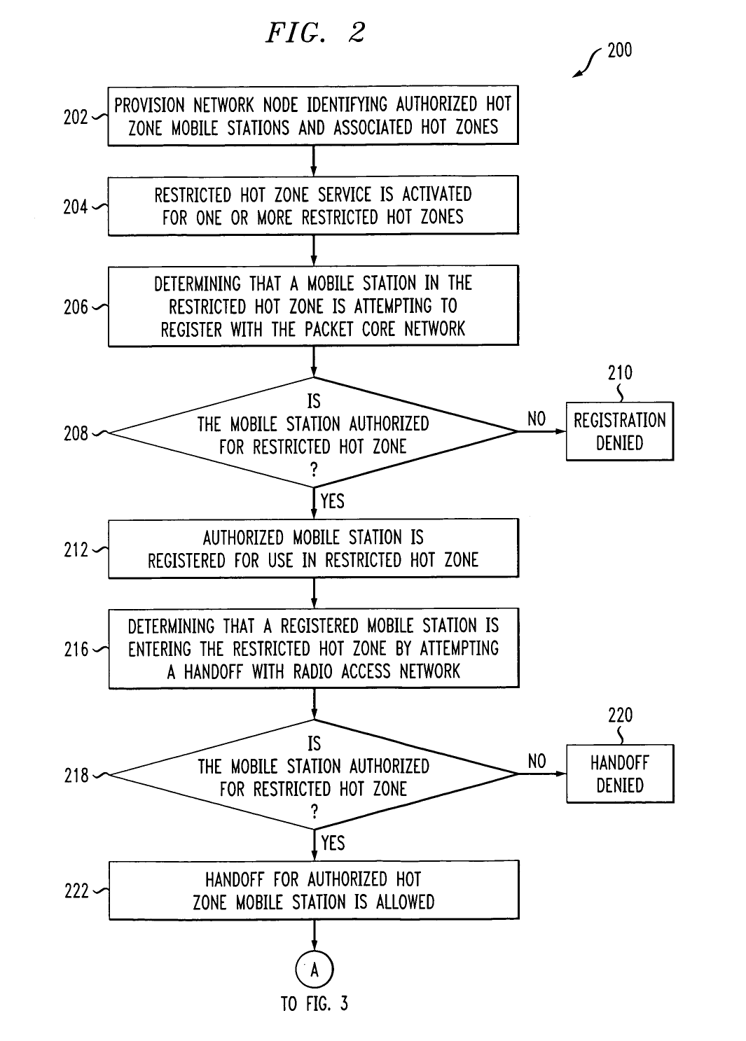

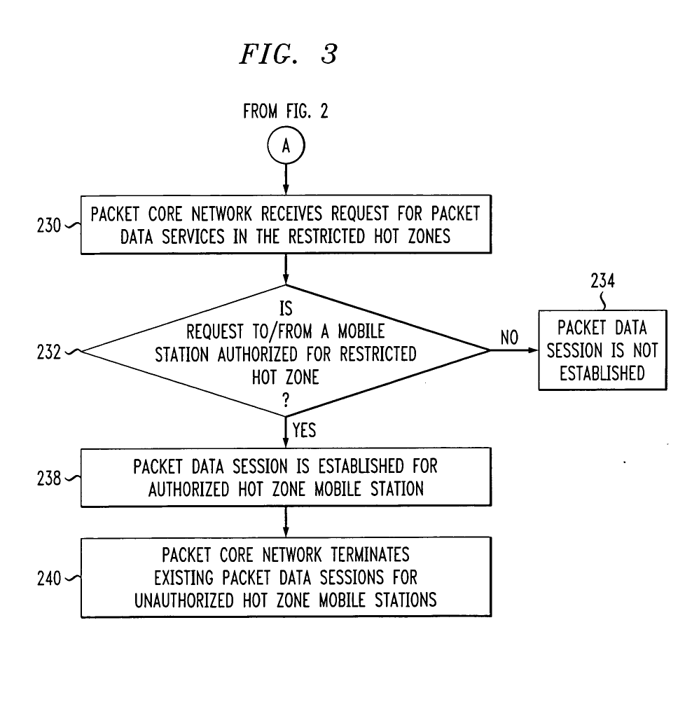

Referring now to FIGS. 2 and 3 a description of the operation of the system 100 described above for providing a restricted Hot Zone service is shown generally at 200. At 202, a network node is provisioned with a Hot Zone database. The Hot Zone database defines separate geographic Hot Zones within the coverage area of the network 102. The Hot Zones can be defined by a geographic designator, such for example a city, a Location Area identifier, such as for example a UMTS Location Area identifier, a Routing Area identifier, or some combination thereof.

The Hot Zone database also identifies the Mobile Stations 112 authorized for use in each Hot Zone when the Hot Zone service is activated for that Hot Zone, as shall be described in further detail below. The Mobile Stations 112 can be identified by a Mobile Station identifier, such as for example a phone number (MDN), an IMSI, or one or more other known identifiers including temporary identifiers. The authorized Hot Zone Mobile Stations identified by the Mobile Station identifiers are then associated with their corresponding Hot Zones in the Hot Zone database in a known manner.

In one embodiment, the network node provisioned with the Hot Zone database can be the SGSN 124. In this example, the Hot Zone database is provisioned on all SGSN's in the network 102. Each SGSN will contain the same information contained in the Hot Zone database to insure consistency. In an alternate embodiment, the HLR 128 is provisioned with the Hot Zone database as described in further detail below.

Upon the occurrence of an extraordinary event, a restricted Hot Zone Service is activated temporarily for one or more Restricted Hot Zones at 204. The restricted Hot Zone Service can be activated by the wireless network Service Provider via an OEM interface.

Activation of the restricted Hot Zone Service will typically cause the disruption of wireless telecommunications services to the majority of subscribers in the restricted Hot Zone, since these subscribers will not be authorized Hot Zone subscribers/Mobile Stations. Therefore, it should be appreciated that this Restricted Hot Zone service will only be activated during an extraordinary event. Examples of extraordinary events can include, State of Emergency, a natural disaster, a terrorist event, or other rare occurrence in which only a limited number of authorized subscribers are allowed to use the PCN 120 for Packet Data Services. The authorized users, also referred to as authorized Hot Zone Mobile Stations, are as a group, a smaller subset of all subscribers to the network 102. That is, the group of authorized Hot Zone Mobile Stations for any given Hot Zone are a subset of all Mobile Stations authorized to engage in wireless packet data sessions in the network 102, including the RAN 110 and PCN 120, when located in the geographic area of the Hot Zone while the restricted geographic Hot Zone service is not activated. They may be the Mobile Stations for police officials, firefighters, and other emergency personnel, among others.

While the Restricted Hot Zone Service is activated for a Hot Zone, a Mobile Station located in the Hot Zone attempts a Registration procedure, also known as an Attach procedure, with the PCN 120. This may occur, for example, when the Mobile Station 112 is powered on. The restricted Hot Zone service determines that a Mobile Station is attempting Registration and Authentication in the Hot Zone at 206. During this procedure, the Mobile Station is informing the SGSN 124 that it wants to have access to the GPRS network in the restricted Hot Zone, and at the same time it identifies its comprehensive set of capabilities. In response, the SGSN 124 authenticates the Mobile Station 112, retrieves its subscription data, and checks whether it is authorized to have access to the GPRS network from its current routing area (i.e., one or more cells served by the same SGSN one or more if which can include the activated restricted geographic Hot Zone).

It should be appreciated that the Mobile Station can attempt Registration/Authentication using any suitable protocol. In one example, which should not be considered limiting, the Mobile Station 112 sends an UMTS Attach Request command to the SGSN 124 which serves the routing area where the Mobile Station is located. The Attach Request command includes a Mobile Station identifier identifying the Mobile Station 112 attempting Registration, such as for example a temporary identifier called the Packet Temporary Mobile Station Identity (P-TMSI), or others. If a temporary identifier is used, the SGSN may acquire the IMSI such as by contacting the SGSN previously serving the Mobile Station. Along with the Mobile Station identifier, the Attach Request can include the identity of the routing area such as a Routing Area Identifier (RAI), as well as information related to the Mobile Station's capabilities is provided. The exact mapping between an RAI and an SGSN IP address is implementation specific and can typically be based on preconfigured mapping tables or DNS queries.

The SGSN 124 processes the Attach Request which can include sending an Update GRPS Location message to the HLR 128 in order to get subscription data for the Mobile Station if this is the first time the Mobile Station attaches to this SGSN. If this is a re-attach to the same SGSN 124, the Mobile Station subscriber profile is already stored in the SGSN from previous attach. The subscription data, as contained in the subscriber profile associated with the Mobile Station, indicates the services that are to be made available to the Mobile Station. This information is communicated to the SGSN 124 via Insert Subscriber Data (ISD) as a response to the Update GPRS Location message.

At this point, the serving SGSN 124 may perform several checks. One of them can be determining if the Mobile Station 112 is authorized for use in the activated restricted geographic Hot Zone at 208. This determination at 208 can be made during Registration/Authentication or as a separate determination. The restricted Hot Zone is identified as a restricted geographic area in which only authorized Mobile Stations are allowed to Register and use the Packet Data Services of the PCN 120 and is provisioned with the SGSN 124 and/or HLR 128 as described above. The authorized Hot Zone Mobile Stations, which are provisioned with the SGSNs 124 and/or HLR 128, are a limited subset of all the Mobile Stations typically authorized to engage in wireless packet data sessions transmitted over the Packet Core Network when located in the same geographic area of the Hot Zone while the restricted geographic Hot Zone service is not activated.

If the Hot Zone database is provisioned on the HLR 128, The SGSN 124 will check for the Hot Zone information received in the Insert Subscriber Data (ISD) for the Mobile Station attempting registration. Alternatively, the SGSN 124 communicates with the HLR 128 to determine if the Mobile Station is an authorized Hot Zone Mobile Station for the Hot Zone. The SGSN 124 sends a Hot Zone Authorization query to the HLR 128 to ascertain if the Mobile Station 112 is in the Hot Zone database described above. The Hot Zone Authorization query can be a new call control message using a protocol suitable to network 102. The Hot Zone Authorization query includes the Mobile Station Identifier.

Upon receiving the Hot Zone Authorization query, the HLR 128 consults the Hot Zone database and sends a Hot Zone Authorization query response back to the SGSN 124 indicating whether the Mobile Station 112 is authorized or unauthorized for the Hot Zone. Alternatively, if the Hot Zone database is provisioned on the SGSN 124, the SGSN consults the Hot Zone database locally to determine if the Mobile Station 112 is authorized or unauthorized for the Hot Zone.

If the restricted Hot Zone service determines that the Mobile Station is unauthorized for the Hot Zone at 208, the SGSN 124 denies the Registration of the Mobile Station at 210, thereby maintaining the availability of the PCN for authorized Hot Zone Mobile Stations while the restricted geographic Hot-Zone service is active. Alternatively, if it is determined that the Mobile Station is authorized for the Hot Zone at 208, the SGSN allows the Registration of the authorized Hot Zone Mobile Station at 212.

The restricted Hot Zone service can also determine that a Mobile Station, already registered with the PCN 120, is entering the Hot Zone at 216. For example, the SGSN 124 can determine that a Mobile Station is attempting a handoff with the RAN 110 in the Hot Zone upon receiving a Location Area/Routing Area Update message from a Mobile Station entering the Hot Zone.

The restricted Hot Zone service then determines if this Mobile Station is an authorized Hot Zone Mobile Station for the Hot Zone at 218 in a manner similar to that described in step 208 above. If it is determined that the Mobile Station is unauthorized for the Hot Zone, the handoff is denied at 220. Alternatively, if it is determined that the Mobile Station is authorized for the Hot Zone, the handoff is allowed to take place so that the authorized Hot Zone Mobile Station can initiate and/or receive packet data services while in the Hot Zone.

The restricted Hot Zone service can also screen requests for initiating packet data sessions involving Mobile Stations located in the Hot Zone and only allow Packet Data Sessions for authorized Hot Zone Mobile Stations. Such requests can include requests for creating a Packet Data Protocol context needed to initiate Packet Data Session, or other suitable requests, include a Mobile Station identifier. These requests can be sent to the SGSN 124 by Mobile Stations attempting to initiate a Packet Data Session with the PCN 120. Or they can be sent from the Internet 116 attempting to initiate a Packet Data Session with the Mobile Station 112. Such requests from the Internet are sent to the GGSN 122 which then sends them to the SGSN 124. Requests for initiating a Packet Data Session with the Mobile Station 112 can also be sent from the PCN 120 to provide Packet Data Services to the Mobile Station, such as for example, a location service application providing the Mobile Station with location specific information, among others.

The restricted Hot Zone service, such as the SGSN 124, determines if the Mobile Station 112 associated with the request is an authorized Hot Zone Mobile Station for the Hot Zone at 232 in a manner similar to that described in step 208 above. If it is determined that the Mobile Station is unauthorized for the Hot Zone, the packet data session is not established at 234. Alternatively, if it is determined that the Mobile Station is authorized for the Hot Zone, the packet data session is established at 238.

Upon activation of the Restricted Hot Zone Service, the PCN 120 can also terminate existing Packet Data Sessions for unauthorized Mobile Stations 112 in the Hot Zone at 240. For example, upon receiving any communication from the Mobile Station, such a communication from an attached but idle (dormant) Mobile Station located in the Hot Zone initiating a service request to start sending data again. Or, if the SGSN 124 receives data from the GGSN 122 for that Mobile Station which results in the SGSN paging the Mobile Station. The paged Mobile Station responds with a Service Request with a type “paging response”. In these instances, the SGSN determines if the Mobile Station is authorized for use in the activated Hot Zone in a manner similar to that described above and kills all calls for unauthorized Mobile Stations. Alternatively the operator can, through OAM, kill all active sessions for Mobile Stations not authorized in the Hot Zone area when the Hot Zone Areas is activated by reviewing each active session to see if the Mobile Station located in the Hot Zone is authorized for use in the active Hot Zone.

After the need for restricting access to the PCN 120 has subsided, the network Service Provider deactivates the restricted Hot Zone service. Upon deactivation, all subscribers to the network 102 can again gain access to the network for receiving Packet Data Services therefrom.

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of restricting wireless packet data sessions transmitted over a Radio Access Network and a Packet Core Network during an extraordinary event comprising:
activating a restricted Hot Zone service creating a temporary restricted geographic Hot Zone within the coverage area of the Radio Access Network during the extraordinary event;
receiving a request for establishing a wireless packet data session with the Radio Access Network and the Packet Core Network for a first Hot Zone Mobile Station located in the Hot Zone;
determining that the first Hot Zone Mobile Station is an authorized Hot Zone Mobile Station, wherein the group of authorized Hot Zone Mobile Station are a subset of all Mobile Stations authorized to engage in wireless packet data sessions transmitted over the Radio Access Network and the Packet Core Network when located in the geographic area of the Hot Zone while the restricted geographic Hot Zone service is not activated;
establishing a wireless packet data session with the Radio Access Network and the Packet Core Network for the authorized Hot Zone Mobile Station;
receiving a request for establishing a wireless packet data session with the Radio Access Network and the Packet Core Network for a second Hot Zone Mobile Station located in the Hot Zone;
determining that the second Hot Zone Mobile Station is an unauthorized Hot Zone Mobile Station; and
rejecting the request thereby not establishing the wireless packet data session for the unauthorized Hot Zone Mobile Station.

2. The method defined in claim 1 further comprising ending the wireless packet data sessions transmitted over the Radio Access Network and Packet Core Network established prior to the initiation of the restricted Hot Zone service for Mobile Stations located in the geographic Hot Zone determined to be unauthorized Hot Zone Mobile Stations for the geographic Hot Zone

3. The method defined in claim 1 further comprising:
determining that a Mobile Station is attempting to register with the Radio Access Network and the Packet Core Network in the Hot Zone;
determining if the Mobile Station is an authorized Hot Zone Mobile Station for the Hot Zone;
determining if the Mobile Station is an unauthorized Hot Zone Mobile Station for the Hot Zone
registering the Mobile Station with the Radio Access Network and the Packet Core Network if the Mobile Station is an authorized Hot Zone Mobile Station; and
denying the registration of the Mobile Station with the Radio Access Network and the Packet Core Network if the Mobile Station is an unauthorized Hot Zone Mobile Station for the Hot Zone.

4. The method defined in claim 1 further comprising:
determining that a Mobile Station is entering the Hot Zone and attempting a handoff with the Radio Access Network;
determining if the Mobile Station is an authorized Hot Zone Mobile Station for the Hot Zone;
determining if the Mobile Station is an unauthorized Hot Zone Mobile Station for the Hot Zone;
allowing the handoff with the Radio Access Network if the Mobile Station is an authorized Hot Zone Mobile Station for the Hot Zone; and
denying the handoff with the Radio Access Network if the Mobile Station is an unauthorized Hot Zone Mobile Station for the Hot Zone.

5. A system for restricting wireless packet data sessions transmitted over a Radio Access Network and a Packet Core Network during an extraordinary event comprising:
means for activating a restricted Hot Zone service creating a temporary restricted geographic Hot Zone within the coverage area of the Radio Access Network during the extraordinary event;
means for receiving a request for establishing a wireless packet data session with the Radio Access Network and the Packet Core Network for a first Hot Zone Mobile Station located in the Hot Zone;
means for determining that the first Hot Zone Mobile Station is an authorized Hot Zone Mobile Station, wherein the group of authorized Hot Zone Mobile Station are a subset of all Mobile Stations authorized to engage in wireless packet data sessions transmitted over the Radio Access Network and the Packet Core Network when located in the geographic area of the Hot Zone while the restricted geographic Hot Zone service is not activated;
means for establishing a wireless packet data session with the Radio Access Network and the Packet Core Network for the authorized Hot Zone Mobile Station;
means for receiving a request for establishing a wireless packet data session with the Radio Access Network and the Packet Core Network for a second Hot Zone Mobile Station located in the Hot Zone;
means for determining that the second Hot Zone Mobile Station is an unauthorized Hot Zone Mobile Station; and
means for rejecting the request thereby not establishing the wireless packet data session for the unauthorized Hot Zone Mobile Station.

6. The system defined in claim 5 further comprising means for ending the wireless packet data sessions transmitted over the Radio Access Network and Packet Core Network established prior to the initiation of the restricted Hot Zone service for Mobile Stations located in the geographic Hot Zone determined to be unauthorized Hot Zone Mobile Stations for the geographic Hot Zone.

7. The system defined in claim 5 further comprising:
means for determining that a Mobile Station is attempting to register with the Radio Access Network and the Packet Core Network in the Hot Zone;
means for determining if the Mobile Station is an authorized Hot Zone Mobile Station for the Hot Zone;
means for determining if the Mobile Station is an unauthorized Hot Zone Mobile Station for the Hot Zone
means for registering the Mobile Station with the Radio Access Network and the Packet Core Network if the Mobile Station is an authorized Hot Zone Mobile Station; and
means for denying the registration of the Mobile Station with the Radio Access Network and the Packet Core Network if the Mobile Station is an unauthorized Hot Zone Mobile Station for the Hot Zone.

8. The system defined in claim 5 further comprising:
means for determining that a Mobile Station is entering the Hot Zone and attempting a handoff with the Radio Access Network;
means for determining if the Mobile Station is an authorized Hot Zone Mobile Station for the Hot Zone;
means for determining if the Mobile Station is an unauthorized Hot Zone Mobile Station for the Hot Zone;
means for allowing the handoff with the Radio Access Network if the Mobile Station is an authorized Hot Zone Mobile Station for the Hot Zone; and
means for denying the handoff with the Radio Access Network if the Mobile Station is an unauthorized Hot Zone Mobile Station for the Hot Zone.

9. A method of restricting wireless packet data sessions transmitted over a Radio Access Network and a Packet Core Network during an extraordinary event comprising:
activating a restricted Hot Zone service creating a temporary restricted geographic Hot Zone within the coverage area of the Radio Access Network during the extraordinary event;
ending the wireless packet data sessions transmitted over the Radio Access Network and Packet Core Network established prior to the initiation of the restricted Hot Zone service for Mobile Stations located in the geographic Hot Zone determined to be unauthorized Hot Zone Mobile Stations for the geographic Hot Zone;
receiving a request for establishing a wireless packet data session over the Radio Access Network and the Packet Core Network for a first Hot Zone Mobile Station located in the Hot Zone;
determining that the first Hot Zone Mobile Station is an authorized Hot Zone Mobile Station, wherein the group of authorized Hot Zone Mobile Station are a subset of all Mobile Stations authorized to engage in wireless packet data sessions transmitted over the Radio Access Network and the Packet Core Network when located in the geographic area of the Hot Zone while the restricted geographic Hot Zone service is not activated;
establishing a wireless packet data session over the Radio Access Network and the Packet Core Network for the authorized Hot Zone Mobile Station;
receiving a request for establishing a wireless packet data session over the Radio Access Network and the Packet Core Network for a second Hot Zone Mobile Station located in the Hot Zone;
determining that the second Hot Zone Mobile Station is an unauthorized Hot Zone Mobile Station; and
rejecting the request thereby not establishing the wireless packet data session for the unauthorized Hot Zone Mobile Station.
